(19) United States
(12) Patent Application Publication
(10) Pub. No.: US 2025/0237747 A1
(43) Pub. Date: Jul. 24, 2025

(54) ANAMORPHIC BEAM TRANSFORMATION TO MATCH A LIDAR SCANNER

(71) Applicant: Liturex (Guangzhou) Co. Ltd., Guangzhou (CN)

(72) Inventor: Wan Kuang, San Ramon, CA (US)

(21) Appl. No.: 18/417,672

(22) Filed: Jan. 19, 2024

(51) Int. Cl. G01S 7/481; G01S 7/4865; G01S 17/10

(52) U.S. Cl. CPC G01S 7/4815; G01S 7/4865; G01S 17/10

(57) ABSTRACT

In at least one embodiment, a LiDAR system include a beam shaping component that anamorphically transforms a linear laser beam that has been collimated by a lens. This transformation minimizes the beam's divergence along the scanning axis while concurrently expanding its dimension perpendicularly to that axis. The anamorphically altered beam is capable of being refocused to correspond to the dimensions of a scanning device (for instance, a MEMS mirror) while preserving the LiDAR system's angular resolution.

### TECHNICAL FIELD

Embodiments of the present invention relate generally to remote sensing, and more particularly relate to an apparatus, a system, and a method for transforming laser beams anamorphically to match a size of an optical scanner (e.g., microelectromechanical system (MEMS) mirror) in a light detection and ranging (LiDAR) device.

### BACKGROUND

In the field of solid-state LiDAR, known for its durability and cost-effectiveness due to the absence of moving parts, precise beam shaping is essential. Solid-state LiDAR encompasses two primary types: flash LiDAR, which illuminates the entire scene at once but suffers from a low signal-to-noise ratio because of its flood illumination approach, and scanning LiDAR, which selectively illuminates parts of the scene.

Scanning LiDAR, whether it uses mechanical methods like MEMS mirrors or non-mechanical techniques such as optical phased arrays or plasmonic metasurfaces, necessitates laser beams with specific shapes and sizes to align with the scanner (e.g., a MEMS mirror). High-power lasers typically emit laser beams with large beam dimensions. Directly collimating these beams to a small diameter to match the size of a scanner may result in a poor LiDAR angular resolution. Scanners with smaller dimensions not only more mechanically robust than scanners with larger dimensions but also easier to mange in terms of temperature control.

### BRIEF DESCRIPTION OF THE DRAWINGS

Embodiments of the disclosure are illustrated by way of example and not limitation in the figures of the accompanying drawings, in which like references indicate similar elements.

FIG. 1 illustrates a LiDAR system in which various embodiments of the invention maybe implemented;

FIG. 2 is a schematic block diagram illustrating a system for transforming laser beams anamorphically according to an embodiment of the disclosure;

FIG. 3 is a schematic diagram illustrating an implementation of the system according to an embodiment of the disclosure;

FIG. 4 is a schematic diagram illustrating another implementation of the system according to an embodiment of the disclosure;

FIG. 5 is a schematic diagram illustrating a process of anamorphic transformation of a laser beam according to an embodiment of the disclosure;

FIG. 6 illustrates an optical intensity distribution of a laser beam before the second prism array 308 according to an embodiment of the disclosure;

FIG. 7 illustrates an example far-field pattern of a laser beam after it has passed through the beam shaper according to an embodiment of the disclosure; and

FIG. 8 illustrates a process of anomorphically transforming a laser beam in a LiDAR device according to an embodiment of the disclosure.

### DETAILED DESCRIPTION

The disclosure describes systems and methods for anamorphic beam transformation to adjust the laser beam's aspect ratio, enabling the creation of optimized beam profiles. This adjustment not only boosts the poor efficiency of LiDAR systems but also ensures high beam quality. In the disclosure, embodiments of anamorphic beam transformation are explained in the context of a MEMS mirror-based scanning LIDAR. However, these embodiments can also apply to other scanning LiDAR systems.

A LiDAR system may include a beam shaper designed to perform an anamorphic transformation on a linear laser beam collimated by a lens. This modification serves to minimize the beam's divergence along the scanning axis while concurrently expanding its dimension perpendicularly to that axis. The anamorphically altered beam is capable of being refocused to correspond to the dimensions of a scanning device (for instance, a MEMS mirror) while achieving the LiDAR system's highest angular resolution. This method offers an advantage over directly collimating a laser beam to a reduced diameter to fit the scanner, which can lead to a low beam divergence angle and compromise angular resolution of the LiDAR system. The beam shaping function can be achieved through the utilization of a pair of prism arrays, a double-sided transmission diffraction grating element, or plasmonic metasurfaces, or topologic optics.

The beam shaper may include two portions, with the first portion dividing a vertical linear laser beam collimated by a cylindrical lens into multiple beam segments and directing all the beam segments towards the second portion as a horizontally aligned linear beam, and with the second portion uniformizing the horizontal linear beam to produce an improved laser beam. The improved laser beam may be reshaped by a curvature on the beam shaper or a separate lens to match the size of a scanner of the LiDAR system.

The disclosure also describes a method of anamorphically transforming a laser beam.

The above summary does not include an exhaustive list of all embodiments in this disclosure. All apparatus and methods in this disclosure can be practiced from all suitable combinations of the various aspects and embodiments described in the disclosure.

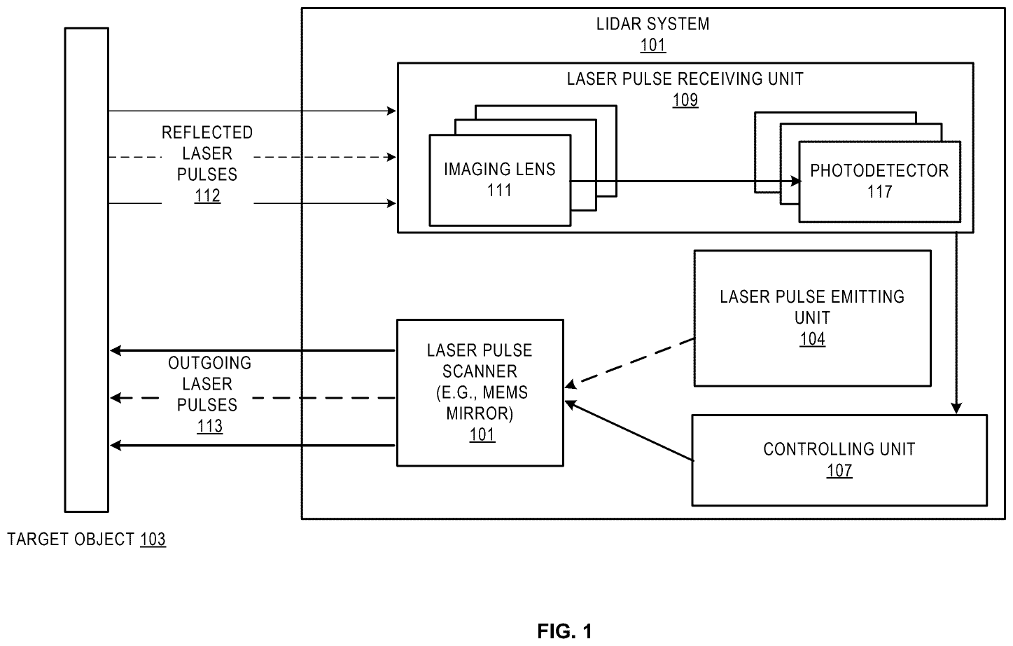

FIG. 1 illustrates a LiDAR system 101 in which various embodiments of the invention maybe implemented.

The LiDAR system 101 can be a solid-state LiDAR system, which can measure distances to objects in an environment by illuminating the objects with laser pulses. Differences in return times of the reflected laser pulses 112 and wavelengths can be used to create a point cloud of the environment. The point cloud can provide spatial location and depth information, for use in identifying and tracking objects.

As shown in FIG. 1, the LiDAR system 101 can include a laser pulse emitting unit 104, a laser pulse scanner 105, a laser pulse receiving unit 109, and a controlling unit 107. The laser pulse emitting unit 104 can include one or more laser emitters that emit beams of short pulses of laser light including photons of various frequencies.

The laser pulse emitting unit 104 emits a beam of outgoing laser pulses 113. The beam of outgoing laser pulses 113 can be steered or scanned by the laser pulse scanner 105 in one or more directions using a variety of mechanisms, including MEMS mirrors, one or more optical phased arrays (OPA), and plasmonic metasurfaces. Each of the one or more directions can be referred to as a steering direction or a scanning direction. The laser pulse scanner 105 can steer one or more beams of laser pulses in a steering direction. Each beam of laser pulses can have a fixed number of pulses.

The controlling unit 107 can include control logic implemented in hardware, software, firmware, or a combination thereof. The controlling logic 107 can drive the other units or subsystems 104, 105 and 109 of the LiDAR system 101 in a coordinated manner and can execute one or more data processing algorithms to perform one or more operations for signal filtering and object detection. For example, the controlling unit 107 can synchronize the laser pulse emitting unit 104 and the laser pulse scanner 105 so that the scanner pulse laser 105 can scan a horizontal field of view in multiple lines.

The laser light receiving unit 109 can collect one or more beams of laser pulses (e.g., beam of laser pulses 112) reflected from a target object 103 using one or more imaging lenses (e.g., imaging lens 111), and focus the beams of laser pulses on one or more photodetectors (e.g., photodetector 117). Each photodetector can be a high-sensitivity photodiode, for example, a linear mode avalanche-photodiode (APD) or a single-photon avalanche diode (SPAD). The one or more photodetectors can convert photons in the reflected beam of laser pulses into electrical pulses. The laser pulse receiving unit 109 can send returned signals incident on each photodetector to the controlling unit 107 for processing.

In an embodiment, laser diodes in the laser pulse emitting unit 104 can operate in a pulsed mode with a pulse repeating at a fixed interval (e.g., every few micro-seconds). The laser diodes and laser drive circuits for providing appropriate bias and modulation currents for the laser diodes can be chosen according to predetermined performance parameters of the LiDAR system 101. Examples of the performance parameters can include a required maximum range of scanned space and resolution.

In an embodiment, MEMS mirrors as a beam scanner have several advantages for solid-state LiDAR compared with other beam scanning approaches. One of the advantages is their smaller sizes, which allow for compact LiDAR system designs, which are beneficial for applications where space and weight are constraints, such as on drones or handheld devices.

In a 1D beam scanning or 2D beam scanning, a horizontally scanned beam from a MEMS mirror is diffused into a vertical laser line by a diffuser lens. The horizontal resolution is determined by the measurement sampling rate and the MEMS mirror scanning frequency. A photodetector array (parallel to the laser line) is placed behind an imaging lens. The number of photo-detector elements determines the vertical resolution. Alternatively, a horizontal laser line can be vertically scanned to cover the entire field of view. In an embodiment, the LiDAR resolution depends on the divergence angle of the laser beam in the scanning direction.

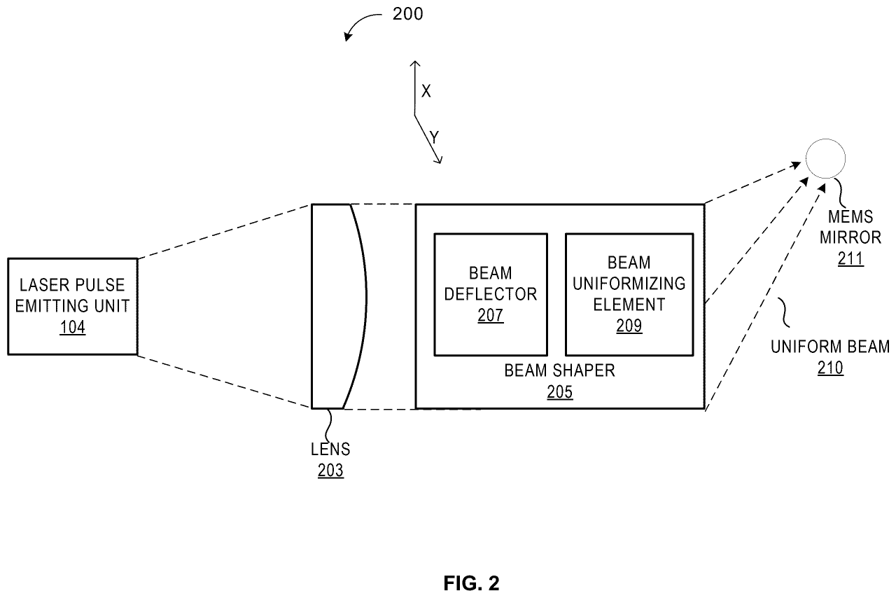

FIG. 2 is a schematic block diagram illustrating a system 200 for transforming laser beams anamorphically according to an embodiment of the disclosure.

As shown in FIG. 2, the system 200 may include the laser pulse emitting unit 104, a lens 203, a beam shaper 205. The laser pulse emitting unit 104 may include an Edge-Emitting Laser Diodes (EELD) array and a vertical-cavity Surface-Emitting Laser (VCSEL) array. The VCSEL array is a type of semiconductor laser array, where each laser (or VCSEL) emits light perpendicular to the surface of the semiconductor chip. The VCSEL array may include multiple VCSELs organized in a grid or linear pattern on a single semiconductor substrate. Each VCSEL in the array can be individually addressed and controlled, allowing for complex and high-resolution emission patterns. In an embodiment, the laser pulse emitting unit 104 emits linear laser beams elongated along the x (vertical) direction, which may be the fast axis of the laser pulse emitting unit 104.

In an embodiment, the lens 203 is a compound cylindrical lens that can project laser beams emitted by emitted by the laser pulse emitting unit 104 on the beam shaper 205 and collimate the laser beams to reduce their divergences while increasing their dimensions.

In an embodiment, the beam shaper 205 may include a beam deflector 207 and a beam uniformizing element 209. The beam deflector 207 and the beam uniformizing element 209 are fabricated as a complementary pair.

In an embodiment, the beam deflector 207 can divide a linear laser beam, elongated in the x-direction and emitted from the laser pulse emitting unit 204, into a number of segments. For example, the beam defector 207 can divide the linear laser beam into an odd number of segments. In various other embodiments, the number of segments can be an event number or any other number that are appropriate to implement the techniques described herein. The beam deflector 207 keeps the direction of the central segment unchanged and deflects one or more segments located above the central segment downwards towards either the right or left side of this central segment. Similarly, the beam deflector 207 deflects one or more segments below the central segment upwards towards either the left or right side of the central segment. Consequently, by the time these segments reach the beam uniformizing element 209, all the segments, including those above and below the central element, are realigned along the y-direction, forming a linear laser beam in alignment with the central segment.

In an embodiment, the beam uniformizing element 209 and the beam deflector 207 are fabricated as a complementary pair such that the beam uniformizing element 209 can increase the dimension of each beam segment in the y direction and reduce the dimension of the beam segment in the x direction. Additionally, the beam uniformizing element 209 can compensates for differences in propagation angles of the beam segments. However, in an embodiment, the beam uniformizing element 209 does not change the divergence angle of each beam segment in the linear laser beam in either the x direction or the y direction.

After the above optical manipulations, the system 200 effectively has altered a laser beam from the lens 203 in one direction disproportionately to another direction, resulting in an anamorphic transformation of the laser beam. Depending on the number of beam segments generated by the beam deflector 207, the anamorphic transformation can take different shapes. For example, the beam deflector 207 divides the laser beam from the lens 203 into three beam segments, the dimension of the laser beam from the lens 203 in the x direction would be one third of the original dimension, and the dimension of the laser beam in the y direction would be three times the original dimension.

After the anamorphic transformation, a laser beam directly emitted by the laser pulse emitting unit 104 would have a reduced divergence in the x direction (e.g., the scanning direction) and an increased divergence in the orthogonal direction, although the divergence of each beam segment is not changed in either direction by the beam uniformizing element 209. Such an anamorphic transformation conserves the total (two-dimensional) optical brightness but can still significantly improve the angular resolution without significant loss of light.

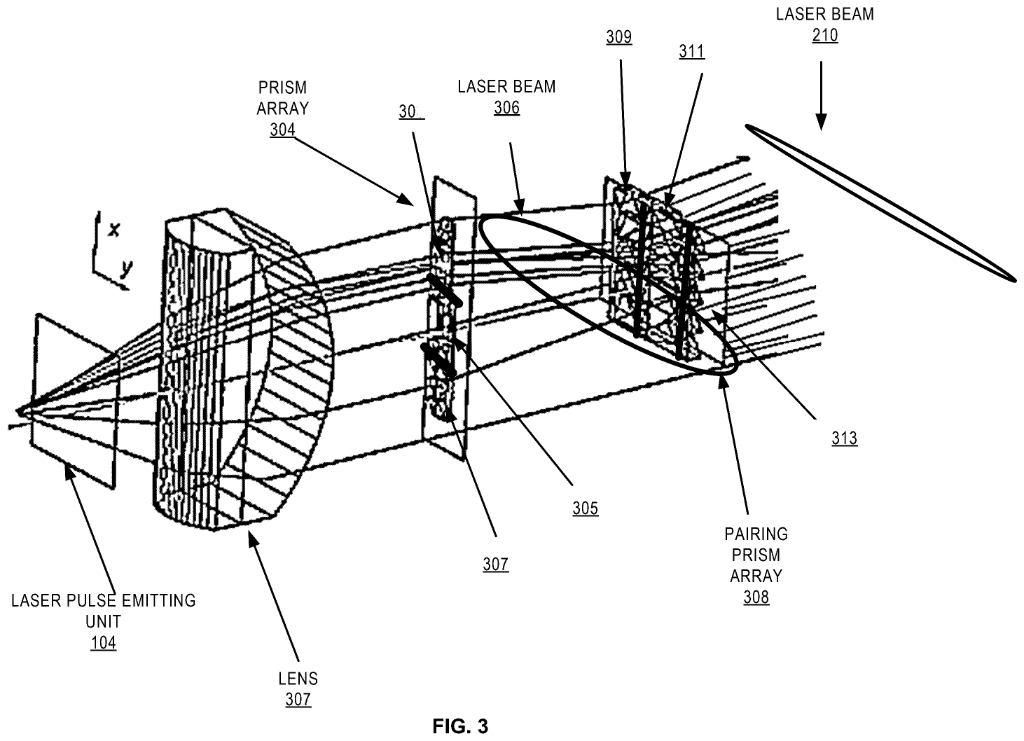

FIG. 3 is a schematic diagram illustrating an implementation of the system 200 according to an embodiment of the disclosure. In this embodiment, a pair of prism arrays 304 and 308 are used to implement the beam shaper 205 described in FIG. 2, and a laser beam from the laser pulse emitting unit 104 is divided into three segments 303, 305, and 307 after passing through the lens 203, which may collimate the laser beam by reducing its divergence and increase its dimension in the x direction while keeping the divergence and dimension in the y direction unchanged. In an embodiment, the lens 203 collimates the laser beam vertically in the y direction.

In an embodiment, the prism arrays 304 and 308 include the same number of prims. The prisms with each prism array have the same structure. The deflection angles of the prisms in the first prism array 304, as well as the spacing between the two prism arrays 304 and 308, are designed to align the three beam segments horizontally (in the y direction) as shown by a laser beam 306 comprising the three beam segments 303, 305 and 307, but they do not overlap before reaching the second prism array 308. However, the three beam segments 303, 305, and 307 have different propagation angles before reaching the second prism array 308 because of the deflection angles on the first prism array 304.

In an embodiment, the second prism array 308 can receive the beam segments 303, 305 and 307 as beam segments 309, 311, and 313, respectively, and uniformize the three beam segments by compensating for the differences in their propagation angles, resulting in a more uniform output beam 210, which can be reshaped either by a curvature on the beam shaper 205 or a lens to match the size a MEMS mirror 211. In an embodiment, the output beam 210 is wider horizontally after passing the second prim array 308, indicating that the laser beam has diverged in the x direction. In an embodiment, the second prism array does not change the vertical dimension of the output laser beam 210. In an embodiment, the vertical dimension of the output laser beam 210 is the same as the vertical dimension of any of the three beam segments 309, 311 and 313.

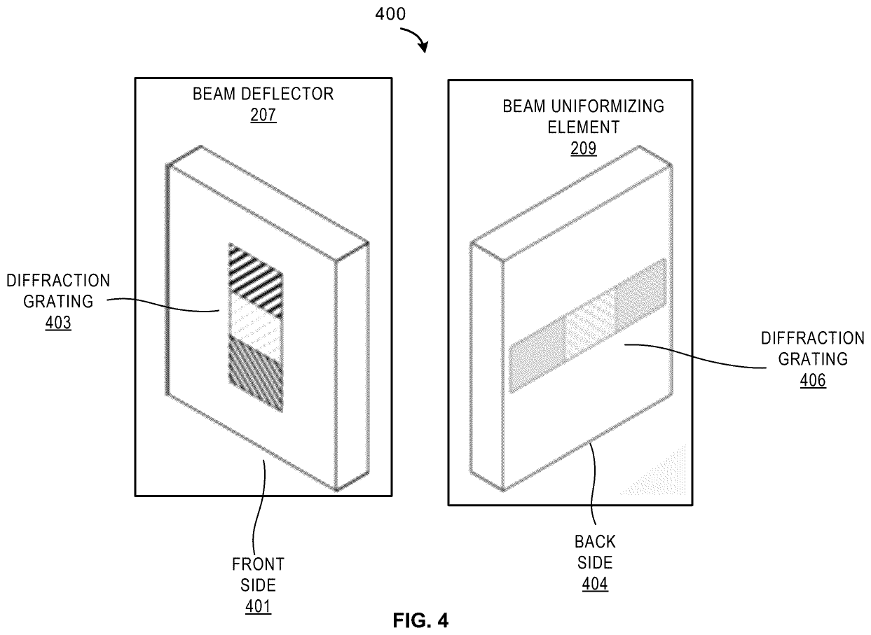

FIG. 4 is a schematic diagram illustrating another implementation of the system 200 according to an embodiment of the disclosure. In this embodiment, a double-sided transmission diffraction grating element 400 is used to implement the beam shaper 205. The transmission grating element 400 may comprise diffraction gratings 403 and 406 that are etched onto both the front side 401 and the back side 404 of a substrate. The diffraction grating 403 on the front side 401 of the substrate splits an incident linear laser beam into three separate beam segments, while the diffraction grating 406 on the back side 404 recombines these segments into a single, transformed, and uniform output beam.

In an embodiment, both diffraction gratings 403 and 406 can be designed in such a way that they diffract light differently in the two orthogonal directions (e.g., x and y direction in FIG. 2), leading to an anamorphic beam profile. For example, anamorphic diffraction gratings have groove spacings that vary in the two principal axes (i.e., fast and slow axis). When light diffract from such a grating, the angles of diffraction will differ in the two axes, leading to an anamorphic transformation. The degree of anamorphism can be adjusted by changing the groove density or the incident angle on the grating.

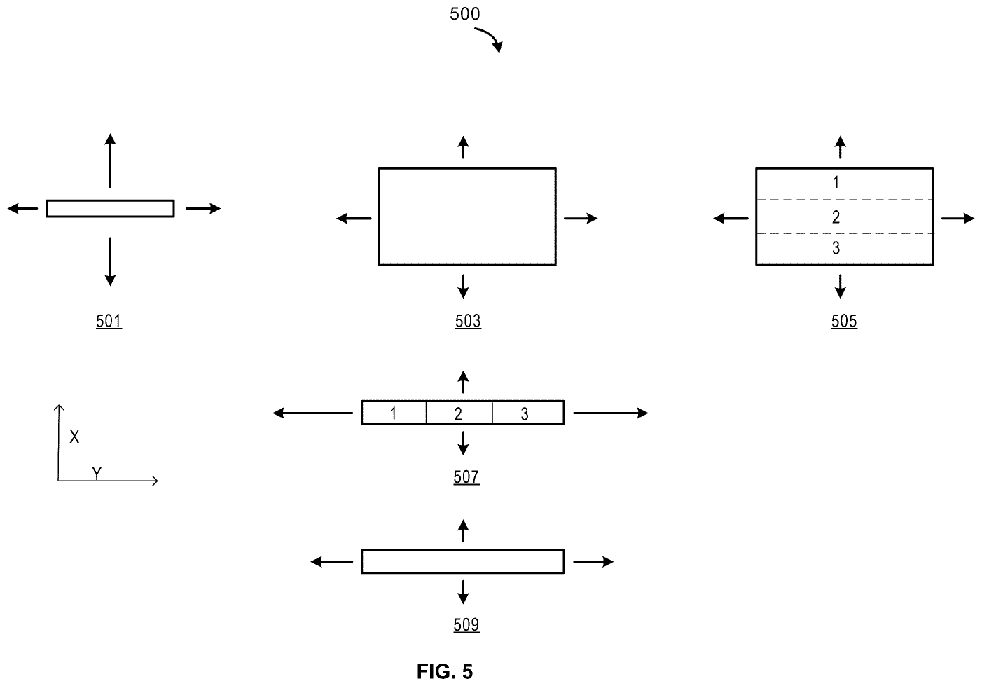

FIG. 5 is a schematic diagram illustrating a process of anamorphic transformation of a laser beam according to an embodiment of the disclosure. More specifically, the figure is a phase-space representation of the anamorphic transformation of a laser beam as it progresses through various optical components in the system 200, ultimately resulting in a beam with modified divergences and dimensions suitable for enhanced applications.

At step 501, the laser emission is characterized by a significant divergence in the fast axis, denoted by a longer arrow in the phase-space representation. To correct this divergence, the beam first encounters a compound cylindrical lens system (not shown), which collimates the beam, leading to a substantial reduction in divergence along the fast axis while concurrently increasing the beam's dimension. This collimation is depicted in step 503 of the figure.

Subsequently, the collimated beam enters, e.g., a prism array at step 505, where it is split into three distinct beam segments 1, 2, and 3. Each beam segment is manipulated differently: the top beam segment of the beam is deflected towards the bottom-left, the bottom segment towards the top-right, and the middle segment remains unaltered in its trajectory, as shown in step 507 of the phase-space diagram The deflection angle and the precise spacing between the two prism arrays as well as other meticulously calculated configurations ensure that the three segments of the beam are realigned horizontally. This horizontal alignment is achieved just before the beam enters the second prism array. The three segments, while horizontally aligned, maintain their distinct propagation directions without overlap, ensuring that each segment contributes uniquely to the final beam profile.

Upon interaction with the second prism array at step 509, the differences in the propagation angles are compensated for, resulting in a uniformly transformed output beam. This manipulation does not alter the divergence angles of the original beam segments but does change the dimensions of the beam of step 503 in the x- and y-axes and the divergence angle of the beam of step 503 in the y direction.

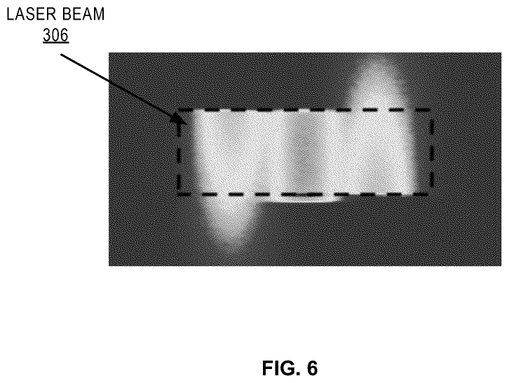

FIG. 6 illustrates an optical intensity distribution of the laser beam 306 before the second prism array 308 according to an embodiment of the disclosure. In the figure, the dash line represents the location of the second prism array 308. The left and right beam segments are both truncated to achieve better beam quality with a tradeoff of marginally small decrease of optical efficiency.

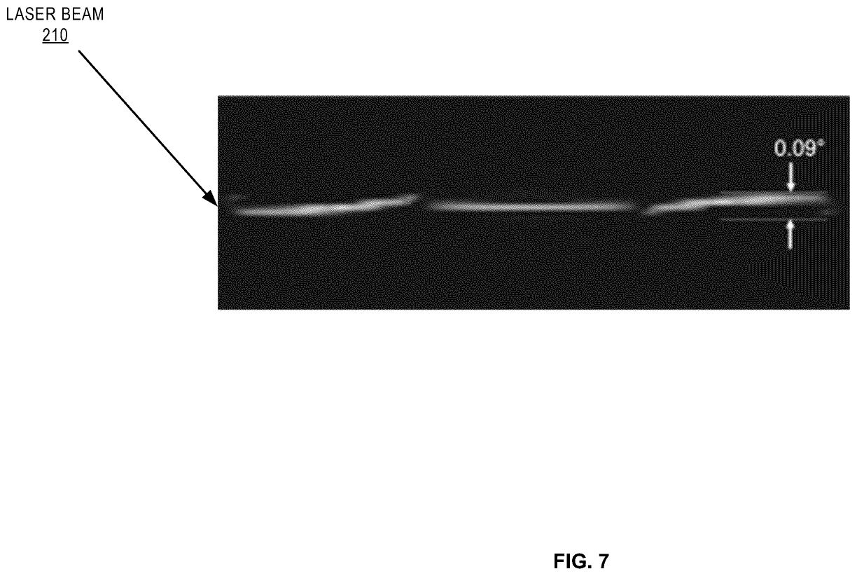

FIG. 7 illustrates an example far-field pattern of the laser beam 210 after it has passed through the beam shaper 205 according to an embodiment of the disclosure. The image in FIG. 7 is a visual representation of the laser intensity distribution in the far field, where the three beam segments are deliberately spaced apart for the purpose of demonstration. The intensity pattern reveals a horizontal alignment with minor vertical spread, which is consistent with the anamorphic concentration process described. The overall divergence of the beam is noted to be very narrow at, e.g., 0.09 degrees, indicating a highly collimated beam.

The above laser beam can be emitted by a1x4 905 nm laser array that has an emission aperture of 10 μm by 1 mm. For this laser beam, the 1/e² beam divergence angles are 40° and 13° in the fast and slow axis respectively. After the beam shaper, the resulting M² in the fast axis decreases from 36 to 12 while M² for the slow axis increases from 880 to 2640. As a result, the beam can be collimated within 0.1° and 2 mm beam diameter in the fast axis. The overall beam divergence is 0.09° accounting for the bending of the outer beam segments. Over 90% total conversion efficiency can be achieved with a beam intensity non-uniformity of better than 10%.

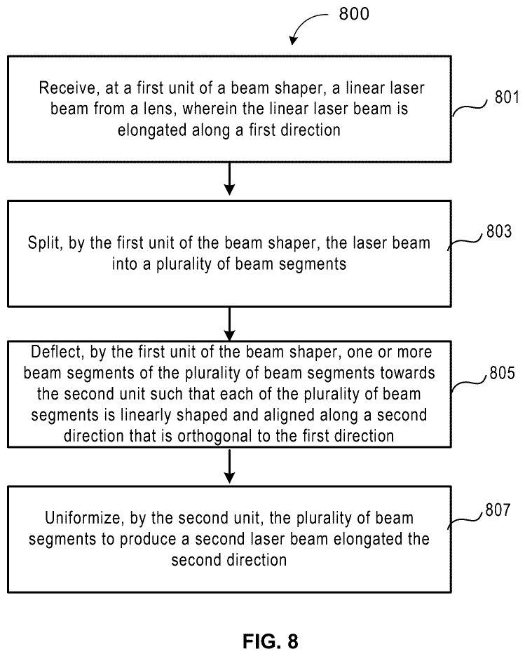

FIG. 8 illustrates a process 800 of anomorphically transforming a laser beam in a LiDAR device according to an embodiment of the disclosure. The process 900 can be performed by a beam shaper, which can a pair of prism arrays or a double-sided transmission grating element.

As shown in FIG. 8, at step 801, a first unit of the beam shaper receives a linear laser beam from a lens, wherein the linear laser beam is elongated along a first direction. At step 803, the first unit of the beam shaper splits the laser beam into a plurality of beam segments. At step 805, the first unit of the beam shaper deflects one or more beam segments of the plurality of beam segments towards the second unit such that each of the plurality of beam segments is linearly shaped and aligned along a second direction that is orthogonal to the first direction. At step 807, the beam shaper uniformizes the plurality of beam segments to produce a second laser beam elongated the second direction.

In particular embodiments, certain features described herein in the context of separate implementations or embodiments may also be combined and implemented in a single implementation or embodiment. Conversely, various features that are described in the context of a single implementation or embodiment may also be implemented in multiple implementations or embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

While operations may be depicted in the drawings as occurring in a particular order, this should not be understood as requiring that such operations be performed in the particular order shown or in sequential order, or that all operations be performed. Further, the drawings may schematically depict one more example processes or methods in the form of a flow diagram or a sequence diagram. However, other operations that are not depicted may be incorporated in the example processes or methods that are schematically illustrated. For example, one or more additional operations may be performed before, after, simultaneously with, or between any of the illustrated operations. Moreover, one or more operations depicted in a diagram may be repeated, where appropriate. Additionally, operations depicted in a diagram may be performed in any suitable order. Furthermore, although particular components, devices, or systems are described herein as carrying out particular operations, any suitable combination of any suitable components, devices, or systems may be used to carry out any suitable operation or combination of operations. In certain circumstances, multitasking or parallel processing operations may be performed.

Various embodiments have been described in connection with the accompanying drawings. However, it should be understood that the figures may not necessarily be drawn to scale. As an example, distances or angles depicted in the figures are illustrative and may not necessarily bear an exact relationship to actual dimensions or layout of the devices illustrated.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes or illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend.

The term “or” as used herein is to be interpreted as an inclusive or meaning any one or any combination, unless expressly indicated otherwise or indicated otherwise by context. Therefore, herein, the expression “A or B” means “A, B, or both A and B.” As another example, herein, “A, B or C” means at least one of the following: A; B; C; A and B; A and C; B and C; A, B and C. An exception to this definition will occur if a combination of elements, devices, steps, or operations is in some way inherently mutually exclusive.

As used herein, words of approximation such as, without limitation, “approximately, “substantially,” or “about” refer to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as having the required characteristics or capabilities of the unmodified feature. In general, but subject to the preceding discussion, a numerical value herein that is modified by a word of approximation such as “approximately” may vary from the stated value by +0.5%, +1%, +2%, +3%, +4%, +5%, +10%, +12%, or +15%. As used herein, the terms “first,” “second,” “third,” etc. may be used as labels for nouns that they precede, and these terms may not necessarily imply a particular ordering (e.g., a particular spatial, temporal, or logical ordering). As an example, a system may be described as determining a “first result” and a “second result,” and the terms “first” and “second” may not necessarily imply that the first result is determined before the second result.

In the foregoing specification, embodiments of the disclosure have been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A beam shaper, comprising:
a first unit; and
a second unit;
wherein the first unit splits a first linear laser beam elongated along a first direction into a plurality of beam segments and deflects one or more beam segments of the plurality of beam segments towards the second unit such that each of the plurality of beam segments is linearly shaped and aligned along a second direction that is orthogonal to the first direction; and
wherein the second unit uniformizes the plurality of beam segments to produce a second laser beam elongated along the second direction.

2. The beam shaper of claim 1, wherein the first unit is a first prism array, and the second unit is a second prism array, wherein the first prism array and the second prism array form a prism array pair, wherein the second prism array compensates for differences in propagation angles of the plurality of beam segments.

3. The beam shaper of claim 1, wherein the first unit is a first diffraction grating embedded on a first side of a substrate, and the second unit is a second diffraction grating embedded on a second side of the substrate.

4. The beam shaper of claim 1, wherein the second laser beam has a smaller divergence angle in the first direction than the first linear laser beam and has a large divergence angle in the second direction than the first linear laser beam.

5. The beam shaper of claim 1, wherein the first linear laser beam is emitted by a vertical-cavity-surfacing-emitting laser array.

6. The beam shape of claim 1, wherein the first direction is a fast axis direction, and the second direction is a slow axis direction.

7. The beam shaper of claim 1, wherein the first unit maintains a direction of at least one of the plurality of beam segments and deflects at least one of the one or more beam segments towards each side of the at least one beam segment whose direction is maintained.

8. The beam shaper of claim 1, wherein the plurality of beam segments includes an odd number of beam segments, wherein the first unit keeps a direction of a central beam segment unchanged and deflects one or more segments located above a central beam segment downwards towards either a right or left side of the central segment and deflects one or more segments below the central segment upwards towards either the left or right side of the central segment.

9. A light detection and ranging (LiDAR) system, comprising:
a beam shaper;
wherein the beam shaper includes a first unit, and a second unit, wherein the first unit splits a first linear laser beam elongated along a first direction into a plurality of beam segments and deflects one or more beam segments of the plurality of beam segments towards the second unit such that each of the plurality of beam segments is linearly shaped and aligned along a second direction that is orthogonal to the first direction, and wherein the second unit uniformizes the plurality of beam segments to produce a second laser beam elongated along the second direction.

10. The LiDAR system of claim 9, wherein the first unit is a first prism array, and the second unit is a second prism array, wherein the first prism array and the second prism array form a prism array pair, wherein the second prism array compensates for differences in propagation angles of the plurality of beam segments.

11. The LiDAR system of claim 9, wherein the first unit is a first diffraction grating embedded on a first side of a substrate, and the second unit is a second diffraction grating embedded on a second side of the substrate.

12. The LiDAR system of claim 9, wherein the second laser beam has a smaller divergence angle in the first direction than the first linear laser beam and has a large divergence angle in the second direction than the first linear laser beam.

13. The LiDAR system of claim 9, wherein the first linear laser beam is emitted by a vertical-cavity-surfacing-emitting laser array.

14. The LiDAR system of claim 9, wherein the first direction is a fast axis direction, and the second direction is a slow axis direction.

15. The LiDAR system of claim 9, wherein the first unit maintains a direction of at least one of the plurality of beam segments and deflects at least one of the one or more beam segments towards each side of the at least one beam segment whose direction is maintained.

16. The LiDAR system of claim 9, wherein the plurality of beam segments includes an odd number of beam segments, wherein the first unit keeps a direction of a central beam segment unchanged and deflects one or more segments located above a central beam segment downwards towards either a right or left side of the central segment and deflects one or more segments below the central segment upwards towards either the left or right side of the central segment.

17. A method of anomorphically transforming a laser beam, comprising:
receiving, at a first unit of a beam shaper, a linear laser beam from a lens, wherein the linear laser beam is elongated along a first direction;
splitting, by the first unit of the beam shaper, the laser beam into a plurality of beam segments;
deflecting, by the first unit of the beam shaper, one or more beam segments of the plurality of beam segments towards a second unit such that each of the plurality of beam segments is linearly shaped and aligned along a second direction that is orthogonal to the first direction; and
uniformizing, by the second unit, the plurality of beam segments to produce a second laser beam elongated the second direction.

18. The method of claim 17, wherein the first unit is a first prism array, and the second unit is a second prism array, wherein the first prism array and the second prism array form a prism array pair, wherein the second prism array compensates for differences in propagation angles of the plurality of beam segments.

19. The method of claim 17, wherein the first unit is a first diffraction grating embedded on a first side of a substrate, and the second unit is a second diffraction grating embedded on a second side of the substrate.

20. The method of claim 17, wherein the second laser beam has a smaller divergence angle in the first direction than the first linear laser beam and has a large divergence angle in the second direction than the first linear laser beam.
